(19) United States
(12) Patent Application Publication
(10) Pub. No.: US 2009/0236816 A1
(43) Pub. Date: Sep. 24, 2009

(54) Skateboard street paddle

(76) Inventor: Stephen McBride, North Ogden, UT (US)

Correspondence Address: Stephen McBride, 3373 North 1050 East, North Ogden, UT, 84414, US

(21) Appl. No.: 12/077,470

(22) Filed: Mar. 19, 2008

Related U.S. Application Data
(63) Continuation of application No. 11/861,425, now abandoned.

(51) Int. Cl. B62M 29/00

(52) U.S. Cl. 280/219

(57) ABSTRACT

A street paddle which permits a rider of an associated skateboard or similar device to smoothly stroke and accelerate down the street using one's arms, hand and upper body, rather than using their foot to accelerate is disclosed. The street paddle is unique in that it allows a skateboard rider to pull and push their way on the street to accelerate, similar to an oarsman on the water, or a skier on snow, yet on the ground. A contact point, or footing, of the street paddle, where the paddle device comes in contact with the ground, connects to the bottom of an elongated shaft of the paddle. The footing comprises form and material that facilitates traction, when applied against a traveled surface, as well as shock dampening action to assist in smoothness and acceleration. As such the street paddle may also be used to decelerate the speed by dragging the footing on the ground in such a way that the friction of the contact slows the skateboard.

### CONTINUITY

This U.S. Non-provisional patent application continues from a U.S. Provisional Patent application Ser. No. 11/861,425 filed Sep. 26, 2007.

### FIELD OF INVENTION

The instant invention disclosed herein relates to skateboards and skateboarding and is more particularly related to paddles used to increase safety, efficacy and mobility when propelling a skateboard.

### DESCRIPTION OF RELATED ART

From nearly the beginning of time there has been the use of a paddle that is used to propel a water vessel across the seas. A paddle typically consists a handle, shaft and a blade which allows a person to propel the water craft forward by efficiently pushing the water backwards, which then, delivers an opposite forward force which propels the water craft. More recently, skiers have utilized ski poles to propel and assist in balancing and stabilizing their down hill or cross country journey.

Currently, there is no paddle made for skateboard use. Presently, skateboards are propelled by placing one foot on the skateboard and “pushing” the board with the opposite foot which provides acceleration of the skateboard. In order to slow down the skateboard, a rider much either drag their foot, jump off the board, create “drag” by turning. or utilize a skateboard break.

The problem with pushing a skateboard by one's foot is three-fold. 1) fatigue sets in quickly because of the constant pushing of one's foot and could cause loss of control, 2) throws the body out of alignment of a natural motion because of the constant pushing of one foot on the road while the other foot maintains balance on the board and 3) maintaining a secure balance with one leg being on the skateboard and the other leg being used for the only ground contact.

### BRIEF SUMMARY AND OBJECTS OF THE INVENTION

In brief summary, this novel invention allows a user of a skateboard or user of any similar wheeled device the ability to be propelled using a stroking motion of a “street paddle” applied against a ground surface

The street paddle consists of a shaft of various lengths and grasping modes to accommodate for the height of a particular rider. The shaft may be constructed of wood, fiberglass, aluminum or other materials which meet weight and strength objectives. On the top end of the shaft, positioned as a grip for the hand, a handle is constructed perpendicular to the shaft, allowing for gripping and positioning for efficacious use. Disposed at the bottom or inferior end of the shaft is constructed an high friction footing that is designed to provide a contact point between the riding surface, such as a riding path, street or road and the shaft. The contact point is designed to permit the street paddle to grip the road in such a fashion that the contour of the contact matches the plane of the road. Additionally, the footing is fixed relative to the shaft for a more secure contact and is made of material which provides shock absorption capabilities. A molded hard rubber may be used for such purposes.

The preferred form of the footing is designed to be securely affixed to the shaft. As an example, the footing may comprise a hub and two high density rubber, non rotate-able, ground contacting members which are securely, but removably affixed thereto. Such members are designed to provide a smooth curvature allowing the street paddle to follow the contour of the road, securing each thrust point as the skateboard is propelled forward. The design also allows a rider to apply forces against a ground surface to slow down the velocity of the skateboard.

It is therefore a primary object to provide a street paddle for use while skate boarding which provides an alternate mode of improving stability and accelerating and decelerating without relying entirely upon action of a foot.

It is another object to provide a street paddle which has a high friction ground contact point which adapts to variable ground contours.

It is yet another object to provide a street paddle which has a replaceable footing permitting a worn part to be replaced.

It is yet another object to provide various weights of street paddles to allow for increased exercise and balance and match skill and physical characteristics of a user.

These and other objects and features of the present invention will be apparent from the detailed description taken with reference to accompanying drawings.

### BRIEF DESCRIPTION OF THE DRAWINGS

FIG. 1 is a front elevation of a street paddle made according to the present invention.

FIG. 2 is a side elevation of the street paddle seen in FIG. 1.

FIG. 3 is an exploded view of the street paddle seen in FIG. 1.

### DETAILED DESCRIPTION OF THE ILLUSTRATED EMBODIMENTS

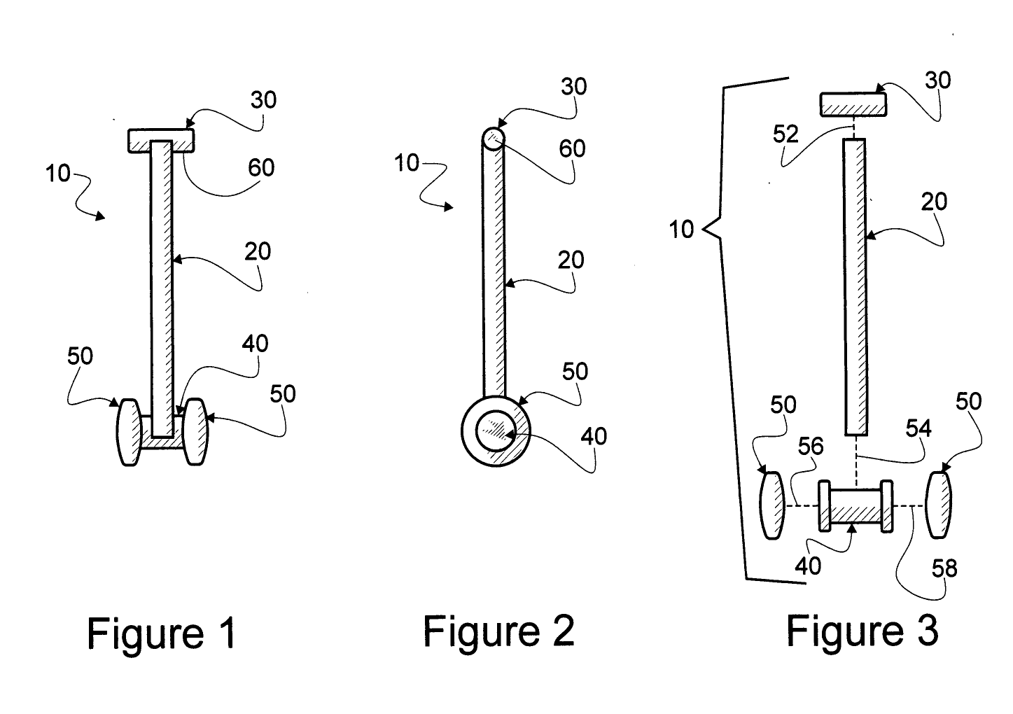

Reference is now made to the embodiments illustrated in FIGS. 1-3 wherein like numerals are used to designate like parts throughout. As seen in FIGS. 1 and 3, a street paddle 10 generally comprises parts consisting of a shaft 20, a superiorly disposed handle 30, an interiorly disposed hub 40 and a pair of ground contacting members, each numbered 50. These parts are seen separately in FIG. 3, with dashed lines 52, 54, 56 and 58 showing associated linkages.

Shaft 20 should be sufficiently sturdy to withstand forces associated with a mature adult traveling at high skateboard velocities striking the ground to decelerate or vary direction of travel. As such, a shaft may be made of wood, carbon fiber or a composite material, which may be formed or molded, and generally be small enough to be grasped by a hand, but large enough to absorb such loads without breaking.

Handle 30 should be made of material which is readily mechanically or adhesively affixed to shaft 20. Handle 30 should provide a gripping surface, such as surface 60 and/or 62 which is comfortably grasped. As such Handle 30 may also be made from wood, carbon fiber or a composite material similar to material used in shaft 20.

Hub 40, as is the case of handle 30, should be made of material which is readily mechanically or adhesively affixed to shaft 20. However, care should be taken to assure hub 40 and associated shaft 20, together, can withstand forces earlier disclosed for shaft 20. Hub 40 may be made from materials similar to those used for shaft 20.

Each ground contacting member 50 may be round, like wheels (see FIG. 2), however each such member should be so affixed to hub 40 that rotation is difficult, if not impossible when member 50 is being applied against a ground surface. Though two members 50 are shown in FIGS. 1 and 3, street paddle 10 may comprise one or more such members 50 within the scope of the instant invention. Further, the object of member 50 is to provide a good resistive contact against a ground impact site. For this reason, member 50 shapes may vary from round to elliptical to geometric polygons and from smooth to having a grooved tread.

It is important that each member 50 is made from an impact resistant material, such as high density rubber. As such materials may wear through use, it is also important, though not necessary, that each member 50 be removable and replaceable upon hub 40.

The invention may be embodied in other specific forms without departing from the spirit or essential characteristics thereof The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A street paddle for use while skateboarding by providing an alternate mode of improving stability and accelerating and decelerating without otherwise relying upon action of a foot being displaced into ground contact, said paddle comprising:
A sturdy, elongated shaft having a girth which may be gripped by a hand and a length which permits ground contact while being hand held;
a handle disposed at the superior end of said elongated shaft;
a footing which provides a sure contact as said footing is disposed against the ground whereby propelling and maneuvering forces may be efficaciously applied thereto, said footing comprising a ground contacting member which is shaped and disposed as a wheel affixed to a hub which is securely affixed to the shaft.

2. The street paddle according to claim 1 comprising the shaft made from fiberglass.

3. The street paddle according to claim 1 comprising the shaft made from carbon fiber.

4. The street paddle according to claim 1 wherein the footing comprises a non-rotating wheel-shaped ground contacting member.

5. The street paddle according to claim 1 comprising a footing comprising a replaceable wheel-shaped ground contacting member.

6. The street paddle according to claim 5 comprising a wheel-shaped ground contacting member made of high density rubber.
